(19) United States
(12) Patent Application Publication
(10) Pub. No.: US 2021/0048192 A1
(43) Pub. Date: Feb. 18, 2021

(54) APPARATUS AND METHOD FOR PASSIVE TORCH TEMPERATURE MODIFICATION

(71) Applicant: SCOTT DANIEL FLEISCHMAN, TALLAHASSEE, FL (US)

(72) Inventor: SCOTT DANIEL FLEISCHMAN, TALLAHASSEE, FL (US)

(21) Appl. No.: 16/994,555

(22) Filed: Aug. 15, 2020

Related U.S. Application Data
(60) Provisional application No. 62/888,226, filed on Aug. 16, 2019.

(51) Int. Cl. F23D 14/38; F23D 14/64; F23D 14/60

(52) U.S. Cl. CPC F23D 14/38; F23D 2203/007; F23D 14/60; F23D 14/64

(57) ABSTRACT

An apparatus and method for using the Venturi effect to introduce a controllable amount of ambient air into the combustion cycle for a flameworking torch, thereby raising or lowering the flame temperature at the torch head, is disclosed. The apparatus includes a control valve to adjust the flow of the ambient air so as to offer control over the actual temperature of the flame during the flameworking and fabrication cycle in multiple application environments, including glassworking.

### BACKGROUND OF THE INVENTION

### 1. Technical Field

This invention relates generally to gas torches that use oxygen and more specifically relates to an apparatus and method to use of ambient air to modify the flame temperature in flameworking applications.

### 2. Background Art

Flameworking is the process of shaping and manipulating glass using oxygen/fuel gas torches. Rods and tubes of glass are heated to high temperatures in the flame of a torch. Within certain temperature ranges depending on the chemical makeup of the glass, the glass becomes soft and can be manipulated into very complex shapes by the flameworker.

Flameworking torches generally employ an oxidizer gas (e.g., oxygen or air), and a fuel gas, typically propane, acetylene, hydrogen or natural gas, to achieve the high flame temperatures required to melt the glass.

Torches used in flameworking are usually designed to achieve the highest possible flame temperature at the torch head. Higher flame temperatures heat the target areas of the glass faster and thereby increase productivity. One of the trade-offs for using higher temperatures in the process is higher gas costs. For example, to increase the flame temperature, a flameworker may use compressed oxygen instead of air, and use acetylene or hydrogen instead of propane for fuel. While the higher flame temperature is generally desirable, due to it's productivity advantages, there are other considerations.

In some cases, higher flame temperatures are not appropriate. One of the most significant problems associated with higher flame temperatures is the propensity to create a situation where the flameworker is actually boiling the glass. As is well known to those skilled in the art, when the flame temperature exceeds a certain temperature threshold, depending on the chemical composition of the subject glass, the glass can boil and bubble, which will irreparably damage the glass and render the glass project worthless.

In recent years, there has been a significant increase in the popularity of cadmium-based colored borosilicate glass for various glass designs. These particular colored borosilicate glasses are very susceptible to the boiling problem when worked with a high temperature flame. In general, the current options available to flameworkers to deal with this are problem are limited and unsatisfactory.

To mitigate the problem of overheating the glass during the fabrication process, some oxygen torches used in flameworking are designed to inject compressed air into the flame to reduce the flame temperature at the torch head. The compressed air used for this application is generally about 79% nitrogen, which is inert and does not participate in the combustion. The compressed air instead, acts as a heat sink to reduce the overall flame temperature delivered to the glass by the flame from the torch head. These specialized torches are very effective at reducing the flame temperature and may offer a significant advantage when working certain glasses, including the increasingly popular cadmium-based colored borosilicate glasses.

While the use of compressed air to reduce the flame temperature is widely practiced, this approach to lowering the flame temperature is coupled with several distinct disadvantages. Preliminarily, the initial cost of acquiring an air compressor suitable for this application can be significant. Additionally, the typical air compressors used for flame reduction purposes are relatively loud and must be in continuous operation throughout the fabrication process. Further, the use of compressed air will also require the introduction of other equipment including a source of electrical power, power cords and extensions, additional air supply hoses to the torch, etc. Finally, these air compressors have a limited lifespan and must be maintained on a regular basis during the life cycle of the compressor and must be replaced when they cease operating.

Accordingly, without additional improvements in the state of the art for controlling flame temperatures in typical flameworking applications, the tradeoffs and use of compressed air in conventional approaches to control the temperature of the flame suggests that the process of achieving lower flame temperatures will continue to be sub-optimal.

### BRIEF SUMMARY OF THE INVENTION

An apparatus and method for using the Venturi effect to introduce ambient air into the combustion cycle for a glassworking torch, thereby lowering flame temperature at the torch head, is disclosed. The apparatus includes a control valve to adjust the flow of the ambient air so as to offer control over the actual temperature of the flame during the flameworking fabrication cycle.

### BRIEF SUMMARY OF THE FIGURES

The various preferred embodiments of the present invention will hereinafter be described in conjunction with the appended drawings, wherein like designations denote like elements, and:

FIG. 1 is a block diagram of an apparatus for passive torch temperature modification in accordance with a preferred exemplary embodiment of the present invention; and

FIG. 2 is a flowchart of a method for passive torch temperature modification in accordance with a preferred exemplary embodiment of the present invention.

### DETAILED DESCRIPTION OF THE INVENTION

This invention uses the Venturi effect to introduce ambient air into the combustion cycle for a flameworking torch, thereby lowering flame temperature at the torch head, is disclosed. The apparatus includes a control valve to adjust the flow of the ambient air so as to offer control over the actual temperature of the flame during the glassworking and fabrication cycle. The Venturi effect is a natural occurrence that happens when a gas flows through a constriction, the velocity of the gas necessarily increases and the pressure decreases. As the gas exits the constriction, the velocity of the gas will decrease and the pressure will rise. This change in pressure is used as the motive force to draw the ambient air into the device to be mixed with the gas for combustion.

At least one practical result of implementing the various preferred embodiments of the present invention is the enhanced ability of the flameworker to controllably reduce the flame temperature at the torch using ambient air as a heat sink, but without all the typical disadvantages associated with the use of an air compressor to achieve a similar result.

The present invention accomplishes flame temperature reduction using excess air in the flame, without all the disadvantages associated with compressed air. The initial capital expense of an air compressor can be eliminated along with the costs of on-going operating and maintenance for the air compressor. There is no need for additional power cords and air hoses and, importantly, the noise associated with operating an air compressor, which can be quite loud and tiring, is completely eliminated.

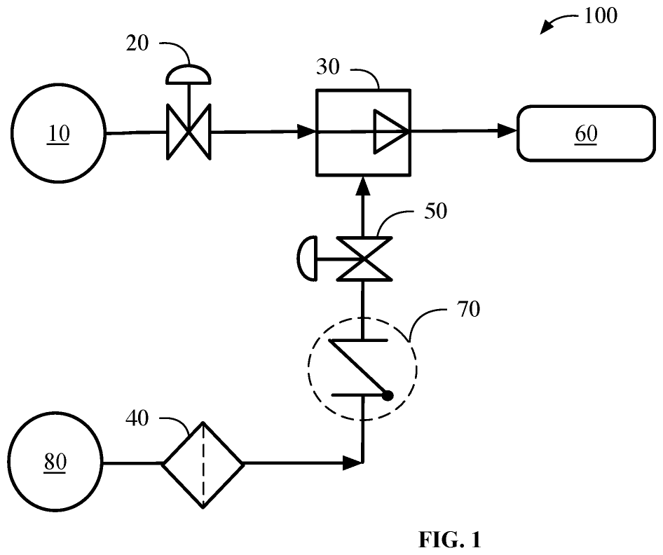

Referring now to FIG. 1, a schematic diagram of an apparatus 100 used for passive torch temperature modification in accordance with a preferred exemplary embodiment of the present invention is depicted. As shown in FIG. 1, a pressurized oxygen supply 10 is connected to an oxygen flow control valve 20. Oxygen flow control valve 20 is connected to the motive fluid input of an injector 30. The outlet of injector 30 is connected the inlet of a torch 60. The vacuum inlet of injector 30 is connected to the outlet of an air flow control valve 50. The inlet of air flow control valve 50 is connected to the outlet of a check valve 70. The inlet of check valve 70 is connected to an air filter 40. Those skilled in the art will recognize that check valve 70 could also be placed between injector 30 and second control valve 50 and it would have substantially the same effect.

In operation, injector 30 receives high pressure oxygen into it's motive fluid input, which exits through the output. The flow of high pressure oxygen through injector 30, creates a vacuum at the vacuum inlet of injector 30. This vacuum is the motive force to draw ambient air 80 through air filter 40, through check valve 70, through air flow control valve 50 and into the vacuum inlet of vacuum ejector 30. The air then mixes with the oxygen in vacuum ejector 30 and exits though the outlet of vacuum ejector 30 and proceeds to the oxygen port of torch 60.

The flow of oxygen is controlled by oxygen control valve 20.

The flow of air is controlled by air control valve 50.

The air is filtered by air filter 40.

Backflow of oxygen is prevented by check valve 70.

Air flow is achieved by the vacuum generated in vacuum ejector 30.

Mixing of the air and oxygen occurs in vacuum ejector 30.

High pressure oxygen supply 10 provides the motive force to drive the oxygen through the venturi constriction contained inside the injector 30. The Venturi effect causes the pressure of the oxygen supplied by high pressure oxygen supply 10 to drop below that of ambient air, thereby creating a vacuum condition. The ambient air is then pulled into the vacuum inlet of injector 30 through air flow control valve 50. The ambient air from air flow control valve 50 mixes with oxygen from supply 10 as it passes through the Venturi constriction contained inside injector 30. As the air/oxygen gas mixture exits injector 30, the flow rate of air/oxygen gas mixture decelerates and, accordingly, the pressure rises back up to a pressure that is above the ambient air.

For most flameworking applications, the supply pressure for oxygen supplies generally run between 3 psig and 125 psig. The pressure for fuel gas supplies usually run much lower, less than 1 psi up to 50 psi at the high end. The most preferred embodiments of the method and apparatus of the present invention are capable of using any compressed fuel gas supply provided it is provided at an appropriate supply pressure.

The air/oxygen gas mixture then proceeds to the oxygen inlet of torch 60, where it is utilized as the oxidizer to create the flame of torch 60. Since the oxygen has now been partially diluted with air, the flame temperature will be reduced, depending on the user selected positioning of air flow control valve 50. The flame temperature reduction is directly controllable, from zero dilution to 50% dilution or more, simply by adjusting air flow control valve 50.

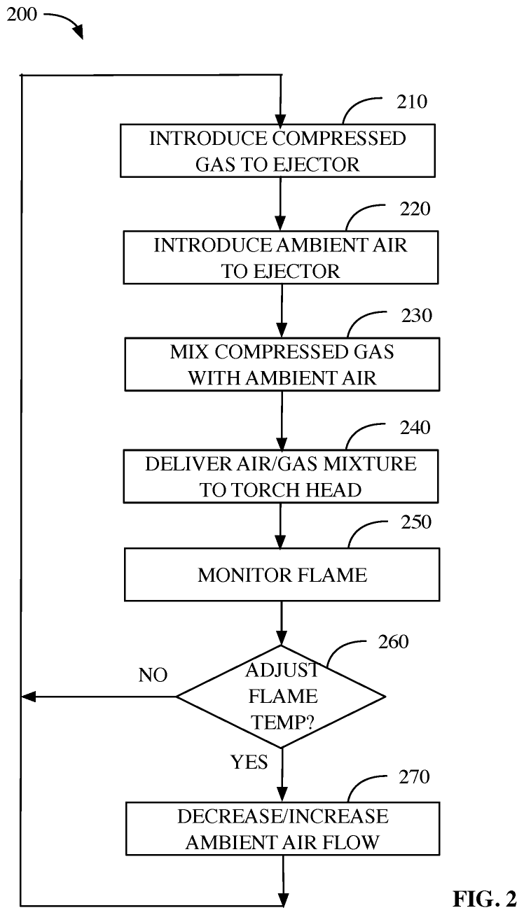

Referring now to FIG. 2, a method 200 for passive torch temperature modification in accordance with a preferred exemplary embodiment of the present invention is depicted. As show in FIG. 2, a compressed gas and ambient air are introduced into an ejector (steps 210 and 220) where they are mixed, and the Venturi effect is used to create a vacuum and induce the flow of the ambient air into the ejector. Once combined, (step 230), the air/gas mixture is delivered to the torch head where it used to create a flame for flameworking (step 240).

The flameworker can monitor the flame temperature (step 250) and determine whether or not it is necessary to adjust the temperature of the flame (step 260). If the flame temperature needs to be adjusted, (step 260=“YES”), then the glassworker can adjust the flow of the ambient air being introduced into the ejector (step 270) so as to increase or decrease the flow of the ambient air into the ejector. This will have the effect of increasing or decreasing the temperature of the flame at the torch head.

In summary, it will be understood that even though certain aspects of the present specification are highlighted by referring to one or more specific embodiments, those skilled in the art will readily appreciate that these disclosed embodiments are only illustrative of the principles of the subject matter disclosed herein. Therefore, it should be understood that the disclosed subject matter is in no way limited to a particular methodology, protocol, and/or material, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, or term so qualified encompasses a reasonable range above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments. Accordingly, the scope of the invention should be determined not by the embodiment(s) illustrated, but by the appended claims and their legal equivalents.

1. An apparatus comprising:
a source of compressed gas;
a first control valve communicatively coupled to the source of compressed gas, the first control valve controlling a flow rate for a quantity of compressed gas;
a second control valve, the second control valve being communicatively coupled to the injector, the second control valve controlling a flow rate for a quantity of ambient air delivered to the injector;
an injector, the injector being communicatively coupled to the first control valve and the second control valve, the injector being configured to:
receive the quantity of compressed gas;
receive the quantity of ambient air; and
alter a pressure associated with the quantity of compressed gas via the Venturi effect; and
a gaseous mixture produced by the injector comprising the quantity of compressed gas and the quantity of ambient air, the gaseous mixture being delivered to a torch head to create a flame and wherein the second control valve is configured to control a temperature associated with the flame by adjusting the flow rate for the quantity of ambient air delivered to the injector.

2. The apparatus of claim 1 further comprising an air filter, the air filter being positioned to filter the quantity of ambient air delivered to the injector.

3. The apparatus of claim 1 further comprising a check valve, the check valve being positioned to between the air filter and the second control valve.

4. The apparatus of claim 1 further comprising:
an air filter, the air filter being positioned to filter the quantity of ambient air delivered to the injector; and
a check valve, the check valve being positioned to between the air filter and the second control valve.

5. The apparatus of claim 1 wherein the temperature associated with the flame is decreased by increasing the amount of ambient air in the gaseous mixture being delivered to the torch head.

6. The apparatus of claim 1 wherein the temperature associated with the flame is increased by decreasing the amount of ambient air in the gaseous mixture being delivered to the torch head.

7. The apparatus of claim 1 wherein the temperature associated with the flame is decreased by increasing the amount of ambient air in the gaseous mixture being delivered to the torch head and the temperature associated with the flame is increased by decreasing the amount of ambient air in the gaseous mixture being delivered to the torch head.

8. A method comprising the steps of:
introducing a quantity of compressed gas to an injector;
introducing a quantity of ambient air to the injector using the Venturi effect;
combining the quantity of compressed gas and the quantity of ambient air inside the injector, thereby creating a mixed gas; and
delivering the mixed gas to a torch head, thereby creating a flame.

9. The method of claim 8 wherein the step of delivering the mixed gas to a torch head, thereby creating a flame, comprises the step of manually adjusting a value to alter the composition of the mixed gas to the torch head based on a temperature associated with the flame.

10. The method of claim 8 further comprising the step of controlling a temperature associated with the flame by adjusting a valve, thereby selectively increasing or decreasing the quantity of ambient air introduced to the injector.

11. The method of claim 8 further comprising the steps of:
monitoring the temperature of the flame; and
adjusting a valve, thereby selectively increasing or decreasing the quantity of ambient air introduced to the injector.

12. The method of claim 8 further comprising the steps of:
monitoring the temperature of the flame; and
adjusting a valve to selectively decrease the quantity of ambient air introduced to the injector based if the temperature of the flame drops below a pre-determined threshold; and
adjusting a valve to selectively increase the quantity of ambient air introduced to the injector based if the temperature of the flame rises above a pre-determined threshold.

13. The method of claim 8 further comprising the step of adjusting the quantity of ambient air introduced to the injector based on the temperature of the flame.

14. The method of claim 8 further comprising the step of adjusting a valve to selectively increase the quantity of ambient air introduced to the injector based if the temperature of the flame rises above a pre-determined threshold.

15. The method of claim 8 further comprising the step of adjusting a valve to selectively decrease the quantity of ambient air introduced to the injector based if the temperature of the flame drops below a pre-determined threshold.
